(19) United States
(12) Patent Application Publication
(10) Pub. No.: US 2020/0095798 A1
(43) Pub. Date: Mar. 26, 2020

(54) CABLING DEVICE

(71) Applicant: GUARDIAR EUROPE, Zwevegem (BE)

(72) Inventor: Timothy MESSELIS, Lauwe (BE)

(21) Appl. No.: 16/469,138

(22) PCT Filed: Dec. 12, 2016
(86) PCT No.: PCT/IB2016/057544

§ 371 Date: Jun. 12, 2019

(51) Int. Cl. E04H 17/16; H02G 3/38; G08B 13/12

(52) U.S. Cl. CPC E04H 17/161; G08B 13/122; H02G 3/286

(57) ABSTRACT

Cabling device for a fence with posts (6), wherein the cabling device comprises several duct elements (1, 2) which are provided to form a first duct which connects to one side of the fence and into which cables (14) extend, wherein these duct elements (1, 2) comprise linear duct elements (1), which are provided to extend between two posts (6) and adapting duct elements (2) which are provided to connect adjacent linear duct elements (1) which are separated by a said post (6), by extending around the said post (6).

This application is a national stage entry under 35 U.S.C. § 371 of PCT/IB2016/057544 filed Dec. 12, 2016.

### FIELD OF THE DISCLOSURE

The present disclosure relates to a cabling device for a fence with posts, wherein the cabling device comprises several duct elements which are provided to form a first duct which connects to one side of the fence and into which cables extend.

The present disclosure also relates to a fence comprising such a cabling device.

### BACKGROUND

Fences are used to prevent people, animals etc. from intruding a certain area. These fences can be provided with a cabling device into which one or several cables extend. These cables can be electrical and/or data cables, which make it possible to provide the fence with detection, access control, lightning, etc. Thus with the aid of the said cables, information about the status of the fence, the area around the fence, etc. can be provided. For example one can detect if contact is made with the fence and/or one can control a video camera.

An embodiment of an existing cabling device comprises a cable duct which is provided to be fixed upon the top side of the fence. When the fence comprises posts, these posts then do not hinder the connection of the cable duct to the fence. However the fixation of a said cable duct to the fence and the application of cables in the duct is complex and time consuming. The location of the cables is also not excellent, such that detection devices etc. connected to the said cables, cannot properly carry out their function.

Another cabling device which is used for fences with posts, comprises multiple cable ducts which are each provided between two successive posts. Openings are made in the posts such that the cables can pass through the posts from one duct into another. Here the cables are at a desired height. However openings need to be made in the posts, which is labour intensive and time consuming. Also the strength of the said posts diminishes. It is also not easy to apply cables into these openings, because the cables need to be pulled through/pushed through these ducts and openings. At the height of the openings it is often difficult to get the cable from the duct into the opening. The cables are also not well protected at the height of the openings.

### SUMMARY

It is therefore an object of the invention to provide a cabling device which can be easily attached to the fence at the desired height and into which the cables can be easily placed.

This object may be achieved by providing a cabling device for a fence with posts, wherein the cabling device comprises several duct elements which are provided to form a first duct which connects to one side of the fence and into which cables extend, wherein these duct elements comprise linear duct elements, which are provided to extend between two posts and adapting duct elements which are provided to connect adjacent linear duct elements which are separated by a said post, by extending around the said post.

Here the cabling device comprises adapting duct elements, which in connected state of the cabling device to the fence, extend around the fence posts. Therefore, no openings for cables need to be provided in the posts, and the posts can keep their strength. Also, the ducts elements form a continuous first duct, such that cables can easily be pulled through/pushed through this first duct. This continuous first duct can be a completely enclosed duct with nearly no openings, or small openings can be present. However, because it is a continuous first duct, the cables which are embedded in the first duct are well protected over the entire length of the first duct.

The linear duct elements extend between two posts at the level of the said side of the fence. Preferably only one linear duct element extends between two successive posts, however two or more linear duct elements can be interconnected to extend between two successive posts. At the height of the posts, adjacent linear duct elements are connected to each other with the aid of one or several adapting duct elements which extend around the respective fence post, at the level of the said side of the fence. For example one adapting duct element can connect two adjacent linear duct elements, or two or more adapting duct elements together can connect two adjacent linear duct elements.

Because the fence posts form no obstacles for this first duct, this first duct can be connected to the fence at the desired height and the connection can be performed in an easy manner. These adapting duct elements can all have the same dimensions, however one can also provide in adapting duct elements with different dimensions, such that for every type of fence post, there is a suitable adapting duct element. For example one can provide a number of standard adapting duct elements.

Preferably the said side of the fence is the inner side of the fence, being the side opposite the side where the possible intruders are present, such that possible intruders cannot sabotage the cabling device.

Further preferably the linear duct elements are provided to extend substantially according to a first longitudinal direction. The first duct then extends substantially according to this first longitudinal direction, except at the level of the posts where the adapting duct elements are present. Even more preferably this first longitudinal direction extends substantially horizontal. Normally the fence is placed such that the posts extend vertically. The linear duct elements then extend perpendicular to the longitudinal direction of the fence posts. If the surface is flat and the posts extend vertically with regard to the surface, then the linear duct elements extend horizontal to the surface onto which the fence is placed. The cables which are provided in said first duct then also extend horizontally. With such a cabling device, a fence can be provided with cables along its lengthwise direction.

In a preferred embodiment the one or several adapting duct elements which are provided to extend around one of the said posts to connect two adjacent linear duct elements separated by the said post, comprise a protruding part which extends around the post and two end parts who respectively are provided to be connected to the respective linear duct element. With the aid of the said protruding part, the adapting duct elements can easily go around the posts. This protruding part, protrudes with regard to the linear duct elements.

Further preferably the protruding part comprises three sections which extend respectively according to the two lateral sides and the small basis of an isosceles trapezoid. With such a shape it is easy to go around a fence post. In an alternative embodiment the protruding part can have a U-shaped form. In another alternative embodiment the protruding part can be a bent duct part.

Even more preferably two adapting duct elements together are provided to extend around a said post to connect two adjacent linear duct elements separated by the said post, wherein each adapting duct element comprises
a first portion, which is provided to be connected to a said linear duct element and to extend according to the first longitudinal direction, such that it forms a said end part;
a second portion, which extends at a distance from and substantially parallel to the first portion;
a third portion, wherein the third portion connects on the one hand to the first portion and on the other hand to the second portion;
   and wherein the said adapting ducts elements are provided to lie facing each other at the height of their second portions, such that these second portions form the small basis of the said isosceles trapezoid and each third portions forms a said respective lateral side of the said isosceles trapezoid.

Here two adapting duct elements are provided to connect two adjacent linear duct elements which are separated by a fence post. Here, viewed along the longitudinal direction of the first section, the second section of a said adapting duct element lies at a distance from the first section of the adapting duct element and the angle between the second section and the third section and between the first section and the third section is greater than 90°.

In an alternative embodiment one adapting duct elements is provided to extend around a said post to connect adjacent linear duct elements separated by the said post, wherein the said adapting duct comprises
two first portions, which are each provided to be connected to a said respective linear duct element and to extend according to the first longitudinal direction, such that they each form a said respective end part;
a second portion, which extends at a distance from and substantially parallel to the first portion;
two third portions, wherein each third portion connects on the one hand to a respective first portion and on the other hand to the second portion;
   and wherein the second portion forms the small basis of the said isosceles trapezoid and the third portions form the lateral sides of the said isosceles trapezoid.

Preferably one or several duct elements each comprise two connectable profiles wherein a first profile is provided to be located opposite the said fence side, and wherein a second profile is connectable to the first profile after the first profile is connected to the fence. Preferably all said duct elements are constructed this way. Here one can first connect all the first profiles to the fence. One can then simple put cables into the first profile and afterwards connect the second profiles to the first profiles. Here one should not pull or push the cables through the duct, one can simple place them in the first profiles. Providing a fence with a cabling device and cables, is here then less labor intensive and less time consuming. These profiles follow the directions of the cables which are provided to extend in the duct elements.

Even more preferably the first profile and the second profile are clickable connectable to each other, such that they can easily and rapidly be connected to each other.

In a preferred embodiment, a part of a said adapting duct element extends within its respective linear duct element, at the height of the connection of the linear duct element and the adapting duct element. This ensures a firm and solid connection between the linear duct elements and the adapting duct elements, such that the first duct is solid and able to contain the cables very well. The cables here cannot move between the linear duct element and the adapting duct element connected to the said linear duct element.

More preferably, at the height of the connection of a said linear duct element and a said adapting duct element, the inner dimensions of the section of the linear duct element, perpendicular to the longitudinal direction of the linear duct element, correspond to the outer dimensions of the corresponding section of the adapting duct element, such that the adapting duct element is form fitted into the linear duct element.

In a very preferred embodiment, the cabling device comprises ballistic protection material. With the aid of the said material, the cables which extend in the duct, are well protected from bullet impacts and similar. This ballistic material is preferably enclosed in one or several duct elements. Alternatively this ballistic protection material is provided to extend between the duct elements and the fence.

Preferably the ballistic protection material is present under the form of sheets. These sheets are then for example embedded in one are several duct elements. These sheets can for example be applied against one or several walls of the duct elements such that the cables which lie in these duct elements are well protected. Preferably these sheets are applied to the walls which face the said side of the fence. These sheets can for example comprise fiberboard and/or ceramic material.

Also preferably the ballistic protection material comprises fiberglass composite.

In a preferred embodiment the cabling device comprises at least one upright duct, which is provided to extend vertical, wherein the said upright duct is provided to be connected to the first duct, such that a cable can extend in both the first duct and the upright duct. Cables can then be connected to a network or a device which is located at the level of the surface or which is placed upon the surface.

In a very preferred embodiment the cabling device comprises a grounding system which is provided to connect the first duct to a said fence post, to ground the cabling device. When there are electrical disturbances, such as a lighting strike, electricity will be grounded such that damages can be avoided.

Further preferably the grounding system comprises a first contact element, which is provided to be connected to a said adapting duct element and a second contact element, which is provided to be connected to the fence post around which the adapting duct element extends, wherein the said grounding system comprises an electrical cable which connects the first contact element with the second contact element such that the first duct is grounded through the said post. The posts are normally embedded in the ground and are often manufactured from an electrically conductive material such as metal, whereby this is a simple way of grounding electricity. Since the adapting duct elements are the closest to the posts, the electrical cable of the grounding system need not to be long.

Preferably at least one linear duct element comprises one or several dividers which extend in the longitudinal direction of the linear duct element and which divide the linear duct element in two or several compartments which extend along the longitudinal direction of the linear duct element. One can then choose which cables are placed in which compartments, such that it can be avoided that cables interfere with each other.

In a very preferred embodiment the cabling device comprises a least a second set of duct elements which are provided to form a second duct which connects to the said side of the fence and into which cables extend. This second duct is then preferably constructed in the same matter as the first duct, which is disclosed above. Also preferably when an upright duct is present, the upright duct is also connected to the second duct.

The cabling device preferably comprises bolts and nuts to fixate the first duct to the said side of the fence, wherein the cabling device comprises a fixation aid comprising hook elements which are provided to hook on the fence and wherein this fixation aid comprises an opening into which a said bolt is provided to engage. With the aid of the fixation aid, the duct can then be well and firmly connected to the fence.

The object may also be achieved by providing a fence with posts comprising a cabling device as described above. All the advantages described above then also apply to this fence comprising the said cabling device. All preferred embodiments and characteristics also apply to this fence.

This fence preferably comprises several panels, wherein the first duct is directly connected to these panels with the aid of connecting elements, such as bolts and nuts. Further preferably these panels are wire panels. Ducts can be easily connected to wire panels with the aid of connecting elements, such as bolts and nuts.

### BRIEF DESCRIPTION OF THE DRAWINGS

The present invention is now explained in greater detail below with reference to the following detailed description of some preferred embodiments of a cabling device according to the present invention. The aim of this description is solely to give illustrative examples and indicate further advantages and particularities and thus cannot be interpreted as a limitation of the field of application of the invention or of the patent rights claimed in the claims.

In this detailed description, reference is made by means of reference numerals to the appended drawings, wherein

FIG. 1 is a detail of a simplified back view of a fence comprising panels and posts, wherein a cabling device according to an embodiment of the invention is attached to the fence;

FIG. 2 is a top view of the fence represented in FIG. 1;

FIG. 3 is a detail of a perspective view of the fence represented in FIGS. 1 and 2, wherein the grounding system and the upright duct are not represented;

FIG. 4 is an exploded view of a linear duct element according to an embodiment of the invention;

FIG. 5 is an exploded view of an adapting duct element according to an embodiment of the invention;

FIG. 6 is an exploded view of the linear duct element of FIG. 4 and the adapting duct element of FIG. 5;

FIG. 7 is a sectional view of the linear duct element represented in FIG. 4 attached to a fence, perpendicular to the longitudinal direction of the linear duct element;

FIG. 8 is a perspective view of a fixation aid according to an embodiment of the invention;

FIG. 9 is a detail of a perspective view of the fence shown in FIGS. 1 and 2, wherein the connection between the cabling device and the fence is shown;

FIG. 10 is a detail view of FIG. 1, wherein the grounding system is clearly visible;

FIG. 11 is a front view of the grounding system according to an embodiment of the invention.

FIG. 12 is a sectional view of an alternative embodiment of a linear duct element according to an embodiment of the invention, perpendicular to the longitudinal direction of the linear duct element, wherein the linear duct element is attached to a fence and ballistic material is present between the linear duct element and the fence.

### DETAILED DESCRIPTION

The figures disclose a first embodiment of a cabling device and an alternative embodiment of a cabling device. They also disclose a fence with posts (6), comprising the said cabling device. Off course other embodiments are possible.

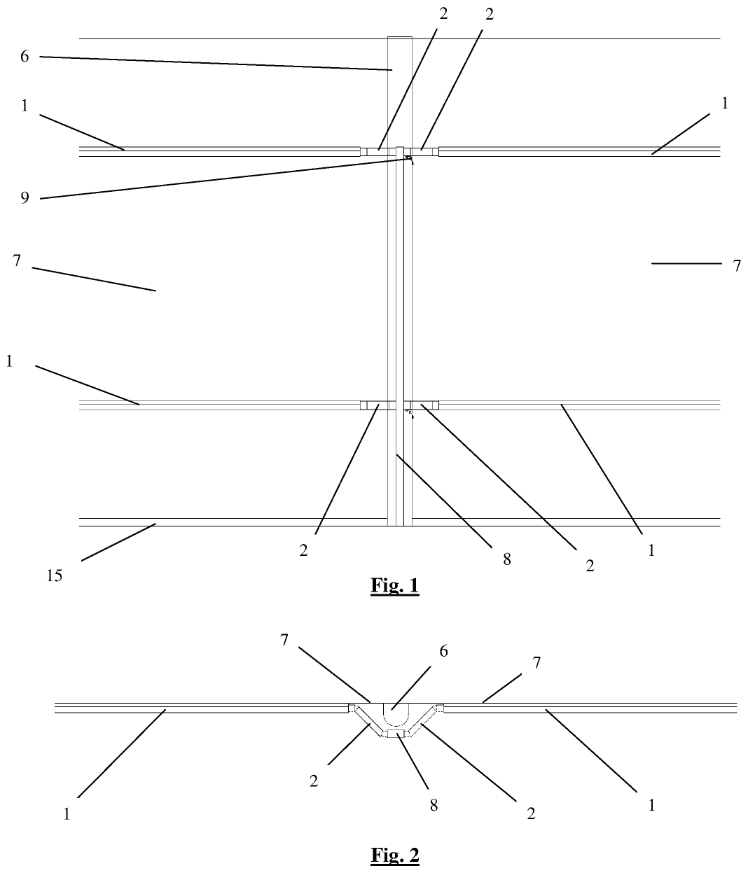

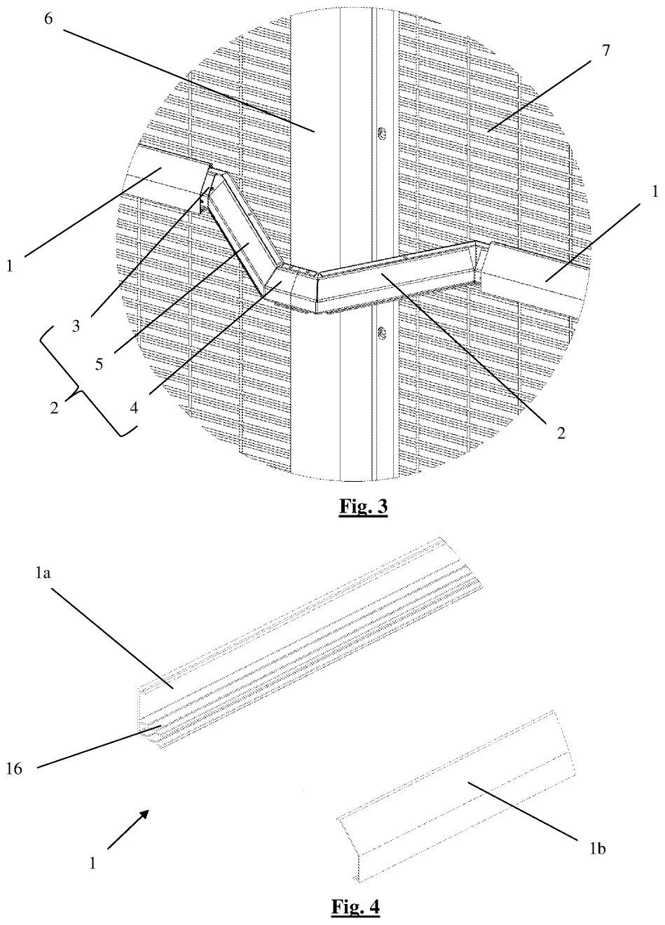

The cabling device is provided to be attached to a fence, wherein the said fence comprises wire panels (7) and posts (6). The posts (6) interconnect the consecutively wire panels (7) and also form the end poles of the fence. The fence is placed upon a surface (15). This is shown in FIG. 1.

The cabling device comprises two sets of several duct elements (1, 2) wherein each set is provided to form a duct which connects to the inner side of the fence and into which cables (14) extend. Here the first set of duct elements (1, 2) is provided to form a first duct and the second set of duct elements (1, 2) is provided to form a second duct, wherein the first duct is attached at a higher position to the fence then the second duct.

Each set of duct elements (1, 2) comprises linear duct elements (1), which are provided to extend horizontally between two posts (6) and adapting duct elements (2) which are provided to connect adjacent linear duct elements (1) which are separated by a said post (6), by extending around the said post (6). These linear duct elements (1) extend horizontal with regard to the surface (15).

For each couple of adjacent linear duct elements (1) which are separated by a said post (6), a pair of two adapting duct elements (2) are used to connect these linear duct elements (1) to each other. A said pair comprises a protruding part which extends around the post (6) and two end parts who respectively are provided to be connected to a respective linear duct element (1). The protruding part comprises three sections which extend respectively according to the two lateral sides and the small basis of an isosceles trapezoid.

Each adapting duct element (2) of the said pair comprises
a first portion (3), which is provided to be connected to a linear duct element (1) and to extend according to the first longitudinal direction, such that it forms a said end part;
a second portion (4), which extends at a distance from and substantially parallel to the first portion (3);
a third portion (5), wherein the third portion (5) connects on the one hand to the first portion (3) and on the other hand to the second portion (4);
   and wherein two said adapting duct elements (2) are provided to lie facing each other at the height of their second portions (4), such that these second portions (4) form the small basis of the said isosceles trapezoid and each third portion (5) forms a said respective lateral side of the said isosceles trapezoid.

Each linear duct element (1) and each adapting duct element (2) comprises two connectable profiles (1a, 1b; 2a, 2b) (FIGS. 4 to 6), which in installed state of the cabling device, substantially follow the direction of the cables (14). The first profiles (1a, 2a) are first attached to the wire panels (7) with the aid of bolts (11) and nuts (12). The second profiles (1b, 2b) are connected to the first profiles (1a, 2a) after the first profiles (1a, 2a) are connected to the fence. The second profiles (1b, 2b) are clickable connectable to their respective first profiles (1a, 2a).

The said end parts of the pair of two adapting duct elements (2) extend within its respective linear duct element (1) and the inner dimensions of the section of the linear duct element (1), perpendicular to the longitudinal direction of the linear duct element (1), correspond to the outer dimensions of the corresponding section of the adapting duct element (2), such that the adapting duct element (2) is form fitted into the linear duct element (1).

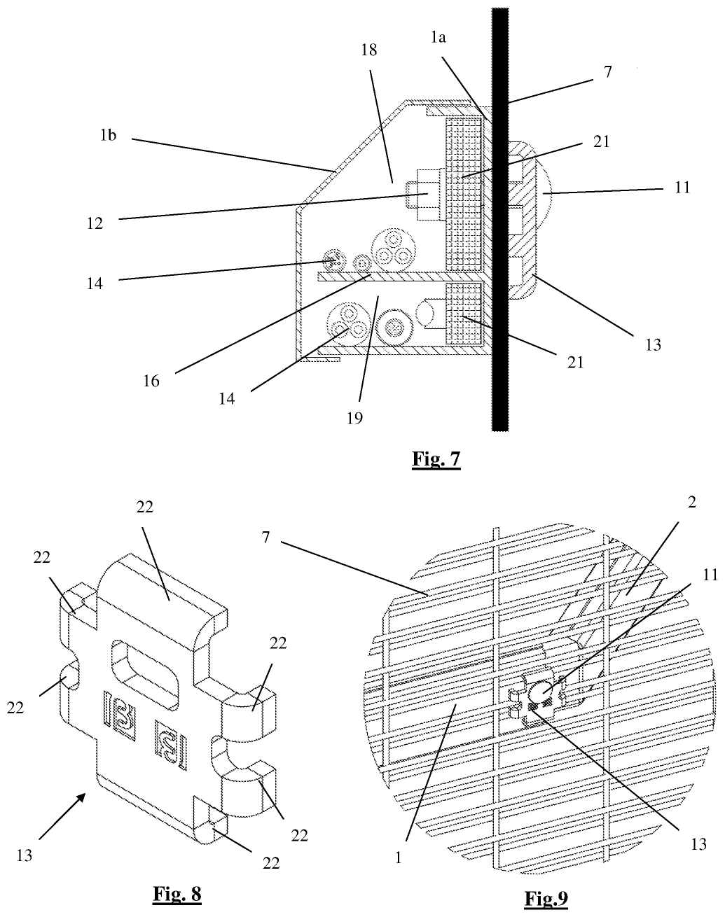

Further, as can be seen in FIG. 7, the first profiles (1a, 2a) comprise sheets (21) of fiberglass composite which are applied to the wall which is opposite the inner side of the fence, such that the cables (14) which are present in the duct or protected from impacts from bullets etc. Fiberglass composite is a ballistic protection material. In the alternative embodiment, represented in FIG. 12, said sheets (21) do not extend in the first profiles (1a, 2a), but said sheets (21) lie between the first profiles (1a, 2a) and the fence.

Further the cabling device comprises a vertical extending duct (8) which is connected to both the first duct and the second duct such that cables (14) can lie in both the vertical extending duct (8) and the second duct or can lie in both the vertical extending duct (8) and the first duct.

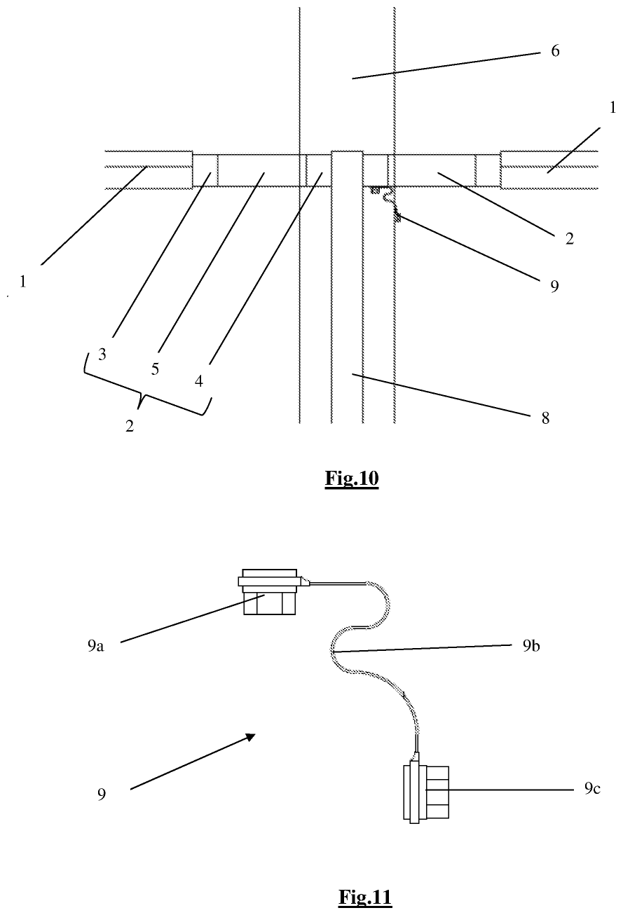

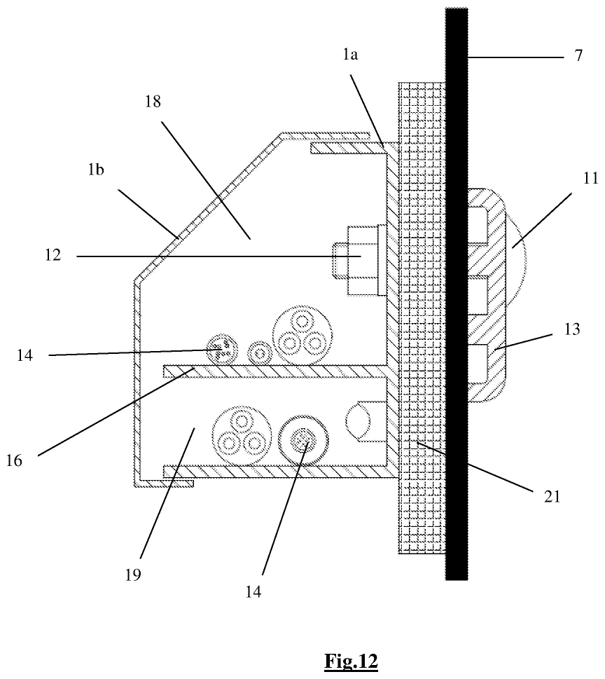

The cabling device also comprises a grounding system (9) (FIGS. 1, 10 and 11), wherein the said grounding system (9) comprises a first contact element (9a), which is connected to a said adapting duct element (2) and a second contact element (9c), which is connected to the fence post (6) around which the adapting duct element (2) extends, and an electrical cable (9b) which connects the first contact element (9a) with the second contact element (9c) such that the cabling device can be grounded through the said post (6).

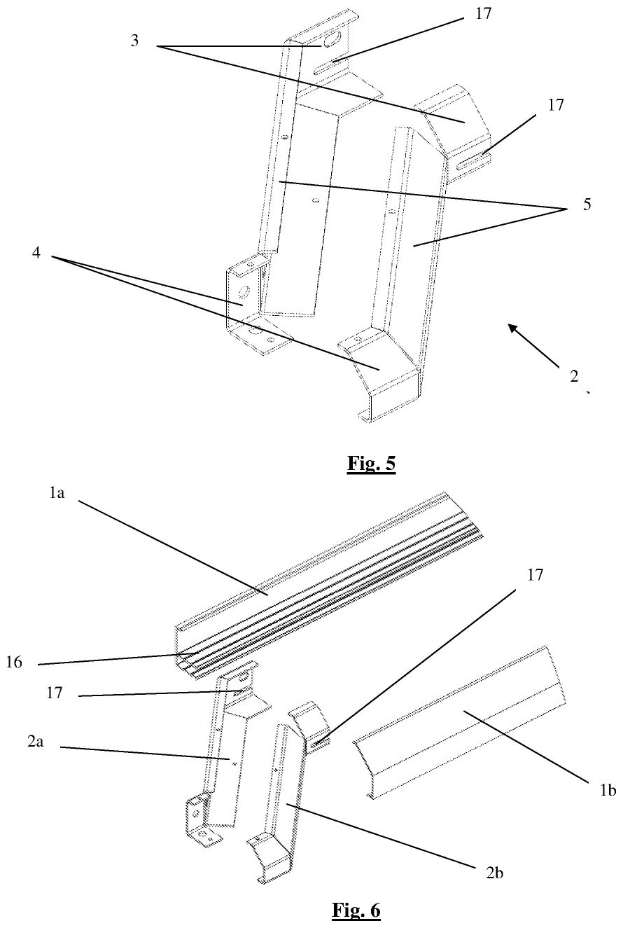

The linear duct elements (1) each comprise one divider (16) which extends in the longitudinal direction of the said linear duct element (1) over its entire length, wherein this divider (16) splits the linear duct element (1) into two compartments (18, 19), such one can choose in which compartment (18, 19) a said cable (14) extends (FIGS. 7 and 12). The said end parts of the adapting duct elements (2) which engages in a said linear duct element (1), comprises grooves (17), see FIGS. 5 and 6, which correspond to the said divider (16), such that they can extend into the said linear duct element (1).

Further the cabling device comprises bolts (11) and nuts (12) to fixate the cabling device to the fence, wherein the cabling device comprises for each set of a said bolt (11) and a said nut (12), a fixation aid (13) with hook elements (22). These hook elements (22) hook onto the wires of the panels (7) and each fixation aid (13) comprises an opening into which a said bolt (11) engages.

Hereafter is described how such a cabling device is attached to the fence and how the cables (14) are put into the cabling device.

Firstly all the first profiles (1a, 2a) of the duct elements (1, 2) are attached to the fence with the aid of the said nuts (12), bolts (11) and fixation aids (13). The first profiles (1a) of the linear duct elements (1) are first placed against the wire panels (7) and after this the first profiles (2a) of the adapting duct elements (2) are placed around the posts (6), such that the part of the first profile (2a) that forms partly the said end part, is placed against the first profile (1a) of its respective linear duct element (1). Then the cables (14) are placed into the said first profiles (1a, 2a). After this the second profiles (1b, 2b) are attached to the first profiles (1a, 1b). The end parts of the adapting duct elements (2) fit into the respective linear duct elements (1), such that firstly the second profiles (2b) of the adapting duct elements (2) are connected to their respective first profiles (2a). After this the second profiles (1b) of the linear duct elements (1) are clicked upon their respective first profiles (1a). The first contact element (9a) of grounding system (9) is then connected to a said adapting duct element (2) and the second contact element (9c) is connected to the post (6), around which the said adapting duct element (2) extends.

1. Cabling device for a fence with posts, comprising:
several duct elements which are provided to form a first duct which connects to one side of the fence and into which cables extend,
wherein the duct elements comprise:
linear duct elements, which are provided to extend between two posts of the fence, and
adapting duct elements, which are provided to connect adjacent linear duct elements, which are separated by a said post, by extending around the said post.

2. Cabling device according to claim 1, characterized in that the linear duct elements are provided to extend substantially according to a first longitudinal direction.

3. Cabling device according to claim 2, characterized in that the first longitudinal direction extends substantially horizontal.

4. Cabling device according to claim 1, characterized in that the one or several adapting duct elements which are provided to extend around one of the said posts to connect two adjacent linear duct elements separated by the said post, comprise a protruding part which extends around the post and two end parts which respectively are provided to be connected to the respective linear duct element.

5. Cabling device according to claim 4, characterized in that the protruding part comprises three sections which extend respectively according to the lateral sides and a small basis of an isosceles trapezoid.

6. Cabling device according to claim 5, characterized in that two adapting duct elements together are provided to extend around a said post to connect two adjacent linear duct elements separated by the said post, wherein each adapting duct element comprises
a first portion, which is provided to be connected to a said linear duct element and to extend according to the first longitudinal direction, such that it forms a said end part;
a second portion, which extends at a distance from and substantially parallel to the first portion; and
a third portion, wherein the third portion connects on the one hand to the first portion and on the other hand to the second portion;
and wherein the said adapting duct elements are provided to lie facing each other at the height of their second portions, such that these second portions form the small basis of the said isosceles trapezoid and each third portion forms a said respective lateral side of the said isosceles trapezoid.

7. Cabling device according to claim 1, characterized in that one or several of the duct elements each comprise two connectable profiles wherein a first profile is provided to be located opposite the said fence side, and wherein a second profile is connectable to the first profile after the first profile is connected to the fence.

8. Cabling device according to claim 7, characterized in that the first profile and the second profile are clickably connectable to each other.

9. Cabling device according to claim 1, characterized in that at the height of the connection of a said linear duct element and a said adapting duct element, a part of a said adapting duct element extends within the linear duct element.

10. Cabling device according to claim 9, characterized in that at the height of the connection of a said linear duct element and a said adapting duct element, inner dimensions of the section of the linear duct element, perpendicular to a longitudinal direction of the linear duct element, correspond to outer dimensions of the corresponding section of the adapting duct element, such that the adapting duct element is form fitted into the linear duct element.

11. Cabling device according to claim 1, characterized in that the cabling device comprises ballistic protection material.

12. Cabling device according to claim 11, characterized in that the ballistic protection material is present in the form of sheets.

13. Cabling device according to claim 11, characterized in that the ballistic protection material comprises fiberglass composite.

14. Cabling device according to claim 1, characterized in that the cabling device comprises at least one upright duct, which is provided to extend vertically, wherein the said upright duct is provided to be connected to the first duct, such that a cable can extend in both the first duct and the upright duct.

15. Cabling device according to claim 1, characterized in that the cabling device comprises a grounding system which is provided to connect the first duct to a said fence post, to ground the cabling device.

16. Cabling device according to claim 15, characterized in that the grounding system comprises a first contact element, which is provided to be connected to a said adapting duct element and a second contact element, which is provided to be connected to the fence post around which the adapting duct element extends, wherein the said grounding system comprises an electrical cable which connects the first contact element with the second contact element such that the first duct is grounded through the said post.

17. Cabling device according to claim 1, characterized in that at least one linear duct element comprises one or several dividers which extend in a longitudinal direction of the linear duct element and which divide the linear duct element in two or several compartments which extend along the longitudinal direction of the linear duct element.

18. Cabling device according to claim 1, characterized in that the cabling device comprises at least a second set of duct elements which are provided to form a second duct which connects to the said side of the fence and into which cables extend.

19. Cabling device according to claim 1, characterized in that the cabling device comprises bolts and nuts to fixate the first duct to the said side of the fence, wherein the cabling device comprises a fixation aid comprising hook elements which are provided to hook on the fence and wherein this fixation aid comprises an opening into which a said bolt is provided to engage.

20. Fence with posts comprising a cabling device, characterized in that the cabling device is a cabling device according to claim 1.

21. Fence according to claim 20, characterized in that the fence comprises several panels, wherein the first duct is directly connected to these panels with the aid of connecting elements, such as bolts and nuts.
